(19) United States
(12) Patent Application Publication
(10) Pub. No.: US 2005/0063434 A1
(43) Pub. Date: Mar. 24, 2005

(54) Semiconductor laser diode having a PCB type lead frame

(76) Inventors: Chan Wang Park, Sungnam (KR); Jong Ik Park, Seoul (KR); Moon Bong Ahn, Yongin (KR); Si Joong Yang, Suwon (KR); Dae Ho Kim, Gunpo (KR)

Correspondence Address: LOWE HAUPTMAN GOPSTEIN GILMAN & BERNER, LLP;Suite 310, 1700 Diagonal Road, Alexandria, VA, 22314, US

(21) Appl. No.: 10/735,623

(22) Filed: Dec. 16, 2003

(30) Foreign Application Priority Data
Sep. 19, 2003 (KR) 2003-65017

(51) Int. Cl. H01S 3/04

(52) U.S. Cl. 372/36; 372/34

(57) ABSTRACT

Disclosed is a laser diode having a PCB type lead frame. In the laser diode, a luminous element functions to emit a laser beam. A frame unit has an upper section mounted with the luminous element and functions to radiate heat generated during creation of the laser beam. A housing has an internal space for receiving the frame unit and an exit hole communicating with the internal space for allowing the laser beam to pass through the same. A Printed Circuit Board (PCB) has a plurality of pattern electrodes formed on an upper face of the PCB, the pattern electrodes being electrically connected with the luminous element. The semiconductor laser diode of the invention has a simple structure to facilitate an assembling process, improve productivity, save manufacturing cost and increase radiating surface area thereby improving heat radiation characteristics. The invention can further prevent a finger of a worker from direct contact with a luminous element when a worker handles components in an assembly line so that precision components are not polluted or damaged.

### BACKGROUND OF THE INVENTION

1. Field of the Invention

The present invention relates to an improved semiconductor laser diode having a PCB type lead frame, more particularly, which has a simple structure to facilitate an assembling process, improve productivity, save manufacturing cost and increase radiating surface area thereby improving heat radiation characteristics.

2. Description of the Related Art

In general, semiconductor laser diodes are operated based upon electric and optical characteristics of p-n junction semiconductor devices which create laser oscillation via forward current. The semiconductor laser diodes are used in a pointer, a laser printer, a scanner and data storages such as a CD-P, CD-ROM, CD-RW, DVD-P and DVD-ROM and optical pickups.

The semiconductor laser diodes are classified into a can type diode, a resin mold type diode and a lead frame type diode. As shown in FIGS. 1A and 1B, a can type laser diode 10 comprises a submount 11, a laser chip LC mounted on an upper portion of the submount 11 to emit a laser beam, a disk-shaped stem 12 having a heat-radiating member 13 projected from an upper face of the stem 12 to a predetermined height and mounted with the submount 11, a photodiode PD mounted on the upper face of the stem 12 and three leads 14 extended downward from the stem 12 for facilitating electric connection of the laser diode 10 with a main board (not shown).

In the can type laser diode 10, the leads 14 are connected respectively with the laser chip LC and the photodiode PD via wire members 15. There is provided a cap member 16 above the stem 12 to protect the laser chip LC and the photodiode PD from the external environment. In an upper central portion of the cap member 16, there is provided a glass member 17 for allowing a laser beam to pass through the same.

FIG. 2 is a perspective view of a resin mold type laser diode. As shown in FIG. 2, the laser diode 20 comprises a submount 21 mounted with a laser chip LC for emitting a laser beam, a central lead frame 24a having a seating section 24c which is widened at a top portion of the central lead frame 24a to mount the submount 21 and two auxiliary lead frames 24b arranged at both sides of the central lead frame 24a. In the laser diode 20, the laser chip LC is electrically connected with the auxiliary lead frames 24b via wire members 25. A packaging material 22 such as transparent epoxy resin is molded around the seating section 24c of the central lead frame 24a and top portions of the auxiliary lead frame 24b into a configuration as shown in FIGS. 1A and 1B where the cap member 16 is placed on the stem 12.

FIGS. 3A and 3B illustrate a lead frame type laser diode. As shown in FIGS. 3A and 3B, a laser diode 30 comprises a photodiode PD, a laser chip LC for emitting a laser beam mounted on an upper portion of the photodiode PD, a central lead frame 34a having a seating section 24c of a relatively large surface area for mounting the photodiode PD which is bonded to the seating section 24c via an adhesive such as epoxy, auxiliary lead frames 34b arranged at both sides of the central lead frame 34a and a guide holder 32 for securing the central and auxiliary lead frames 34a and 34b in vertical positions while exposing the photodiode PD from the front.

The photodiode PD and the laser chip LC are electrically wire-bonded with the auxiliary lead frames 34b via wire members 35. The guide holder 32 is arranged in an internal space 37 of a housing member 36 which is perforated with an exit hole 37a for allowing a laser beam to pass through the same.

Each of the conventional laser diodes 10, 20 and 30 generates heat when the laser beam is created from the energized laser chip LC in response to application of external electric power. Heat is transferred to the submount 11 or 21 mounted with the laser chip LC and the integral photodiode PD, and then radiated to the outside via the heat-radiating member 13 provided on the stem 12 or via the central lead frames 24a or 34a.

According to the prior art, however, the area for radiating heat to the outside is not large enough. In the case of the can type laser diode 10, heat from the laser chip LC raises the temperature of the stem 12 and the heat-radiating member 13 on which the laser chip LC as a heat source is mounted, thereby thermally distorting the same. In the case of the resin mold and lead frame type laser diodes 20 and 30, heat from the laser chip LC raises the temperature of the packaging material 22 and the guide holder 32 in direction contact with the central lead frames 24a and 34b, thereby thermally distorting the same.

Further, although the can type laser diode 10 can correctly emit the laser beam, it has a large number of components and a complicated assembly structure, thereby raise fabrication cost, prolong manufacturing time excessively and degrade productivity.

On the other hand, since the resin mold type laser diode 20 has a simpler structure compared with the can and lead frame type diodes 10 and 30, the manufacturing cost of the resin mold type laser diode 20 is less expensive than those of the can and lead frame type diodes 10 and 30. However, the resin mold type laser diode 20 has a lower optical density per unit area, and the luminescent center of the luminous element can be changed since the packaging material 22 tends to be thermally distorted.

Further, the can and lead frame type laser diodes 10 and 30 have a problem that when the stem 12 and the guide holder 32 are assembled to the cap member 16 and the housing member 36, a finger of a worker tends to directly contact the luminous element such as the laser chip LC that is a precision component thereby polluting the same.

### SUMMARY OF THE INVENTION

The present invention has been made to solve the foregoing problems and it is therefore an object of the present invention to provide a semiconductor diode having a Printed Circuit Board (PCB) lead frame which is simplified in structure to save manufacturing cost, improve productivity and increase radiating surface area thereby improving radiation characteristics.

It is another object of the invention to provide a semiconductor laser diode having a PCB type lead frame which can prevent a finger of a worker from direct contact with a luminous element when a worker handles components in an assembly line.

According to an aspect of the invention for realizing the object, there is provided a laser diode having a PCB type lead frame. The laser diode of the invention comprises: a luminous element for emitting a laser beam; a frame unit having an upper section mounted with the luminous element and functioning to radiate heat generated during creation of the laser beam; a housing having an internal space for receiving the frame unit and an exit hole communicating with the internal space for allowing the laser beam to pass through the same; and a Printed Circuit Board (PCB) having a plurality of pattern electrodes formed on an upper face of the PCB, the pattern electrodes being electrically connected with the luminous element.

It is preferred that the luminous element includes a photodiode which is die bonded to an upper section of the frame unit and a laser chip which is die bonded to an upper face of the photodiode.

It is preferred that the frame unit comprises a metal plate having an excellent heat conductivity.

It is also preferred that the frame unit has a wing section formed at both sides thereof, and is mounted within the internal space of the housing.

It is preferred that the housing has holding grooves formed axially in inner peripheral portions of the internal space of the housing, and wherein the wing section includes wings which are extended laterally from both lateral peripheral portions of the frame unit to be inserted into the holding grooves and fixed therein.

Also it is preferred that each of the holding grooves has a fitting groove extended radially in a top portion thereof.

It is preferred that the wing section includes arc-shaped wings which are elastically contacted with inner peripheral portions of the internal space of the housing.

It is preferred that the arc-shaped wings are projected forward or backward perpendicular to a front or rear face of the frame unit.

It is also preferred that the frame unit has arc-shaped protective wings formed at both lateral peripheral portions of the frame unit to surround and protect the luminous element.

It is preferred that each of the protective wings has an end which is formed higher than the uppermost portion of the luminous element.

It is preferred that the pattern electrodes of the PCB are connected with the luminous element via wire members.

It is also preferred that the pattern electrodes of the luminous element are extended to an upper peripheral portion of the PCB in close proximity of the luminous element to form upper terminals in contact with lower ends of the wire members.

Also it is preferred that the PCB comprises a single sided PCB having a front face on which the pattern electrodes are formed.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a perspective view of a general can type semiconductor laser diode;

FIG. 1B is an exploded view of FIG. 1A;

FIG. 2 is a perspective view of a general resin mold type semiconductor laser diode;

FIG. 3A is a perspective view of a general lead frame type semiconductor laser diode;

FIG. 3B is a partial magnification of FIG. 3A;

FIG. 4 is an exploded perspective view of a semiconductor laser diode having a PCB type lead frame according to a first embodiment of the invention;

FIG. 5 is a perspective view of an assembly including a luminous element, a frame unit and a PCB in the semiconductor laser diode having a PCB type lead frame according to the first embodiment of the invention;

FIG. 6A is a magnified perspective view of the semiconductor laser diode having a PCB type lead frame according to the first embodiment of the invention;

FIG. 6B is a plan view of FIG. 6A;

FIG. 7 is a longitudinal sectional view of the semiconductor laser diode having a PCB type lead frame according to the first embodiment of the invention;

FIG. 8 is an exploded perspective view of a semiconductor laser diode having a PCB type lead frame according to a second embodiment of the invention;

FIG. 9A is a magnified perspective view of the semiconductor laser diode having a PCB type lead frame according to the second embodiment of the invention;

FIG. 9B is a plan view of FIG. 9A;

FIG. 10 is a perspective view of an assembly including a luminous element, a frame unit and a PCB in the semiconductor laser diode having a PCB type lead frame according to the second embodiment of the invention;

FIGS. 11A and 11B illustrate a process of assembling the frame unit to the housing in the semiconductor laser diode having a PCB type lead frame according to the first embodiment of the invention;

FIGS. 12A and 12B illustrate a process of assembling the frame unit to the housing in the semiconductor laser diode having a PCB type lead frame according to the second embodiment of the invention; and

FIGS. 13A through 13C illustrate a process of fabricating a luminous element used in the semiconductor laser diode having a PCB type lead frame of the invention.

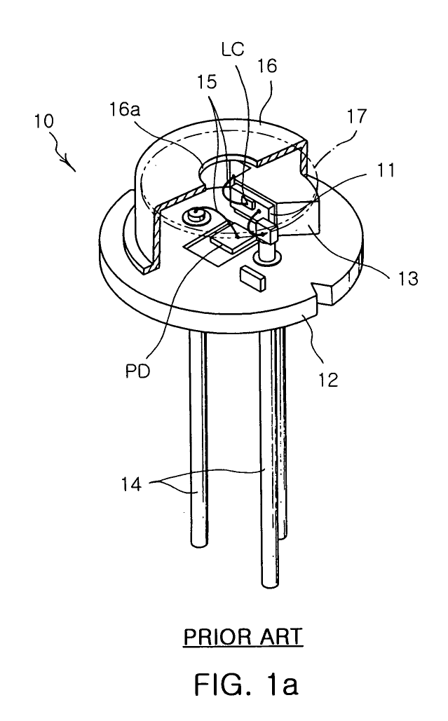

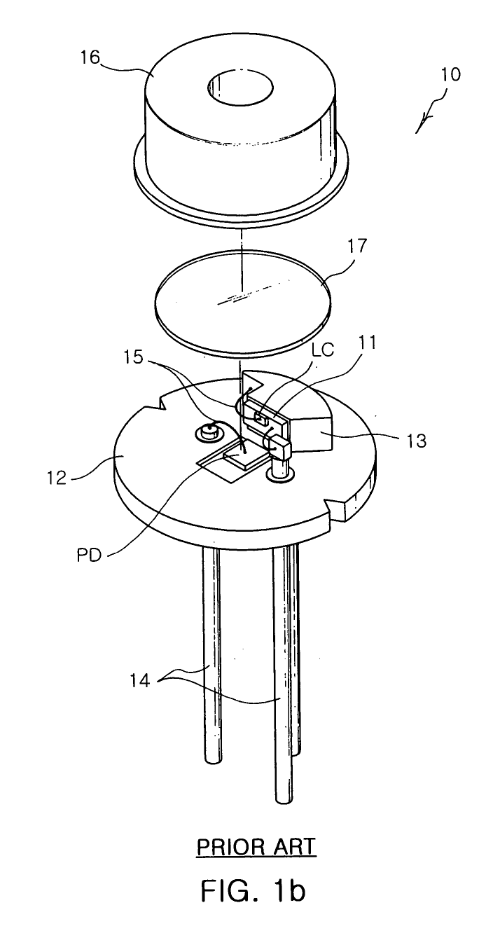

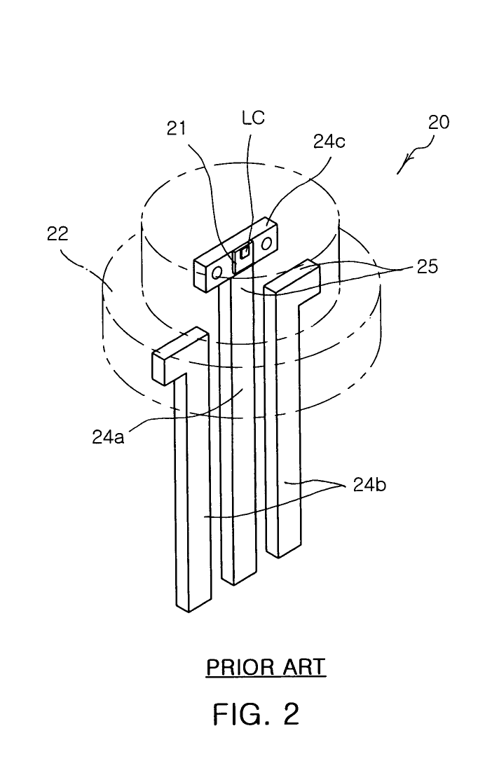

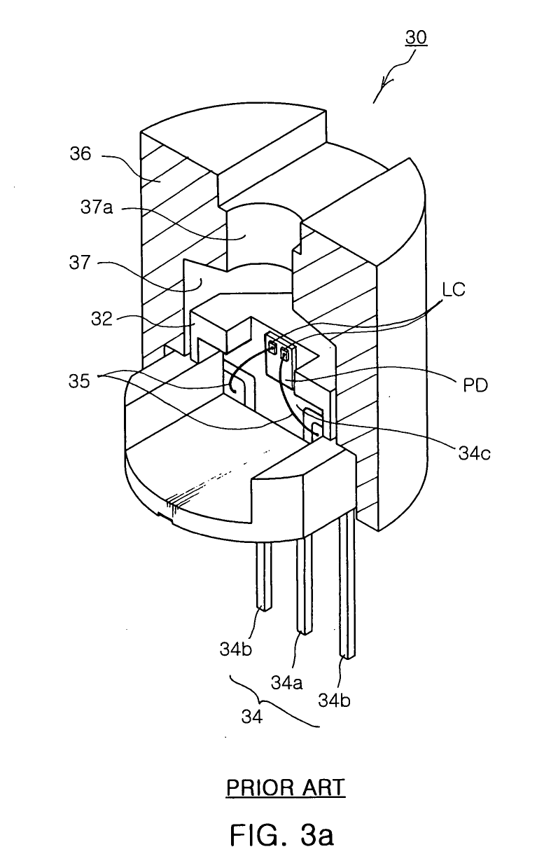

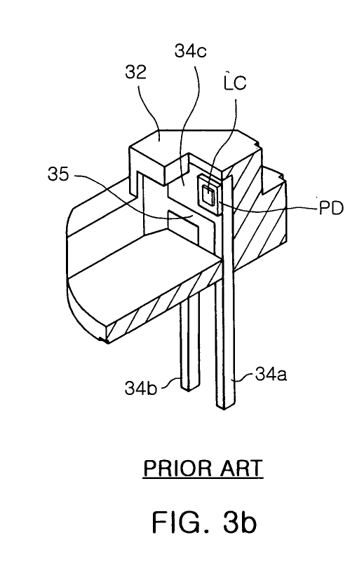

### DETAILED DESCRIPTION OF THE PREFERRED EMBODIMENT

The following detailed description will present preferred embodiments of the invention in reference to the accompanying drawings.

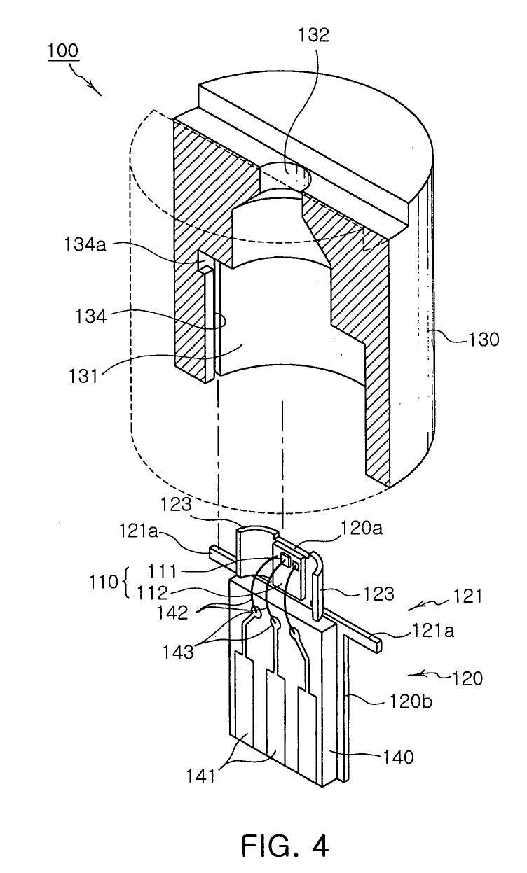

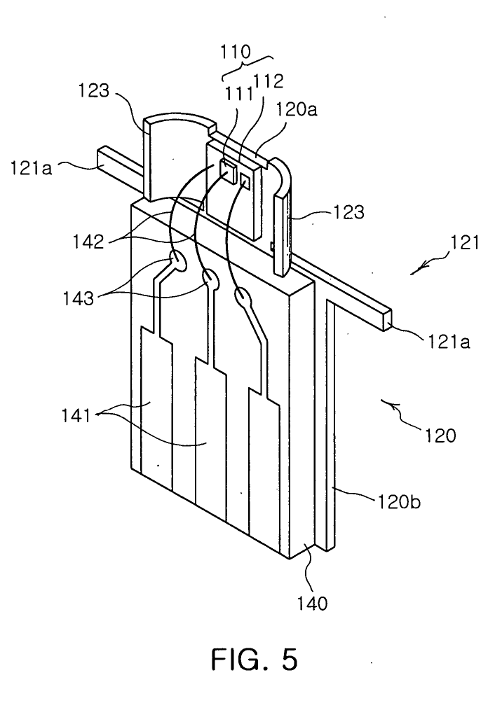

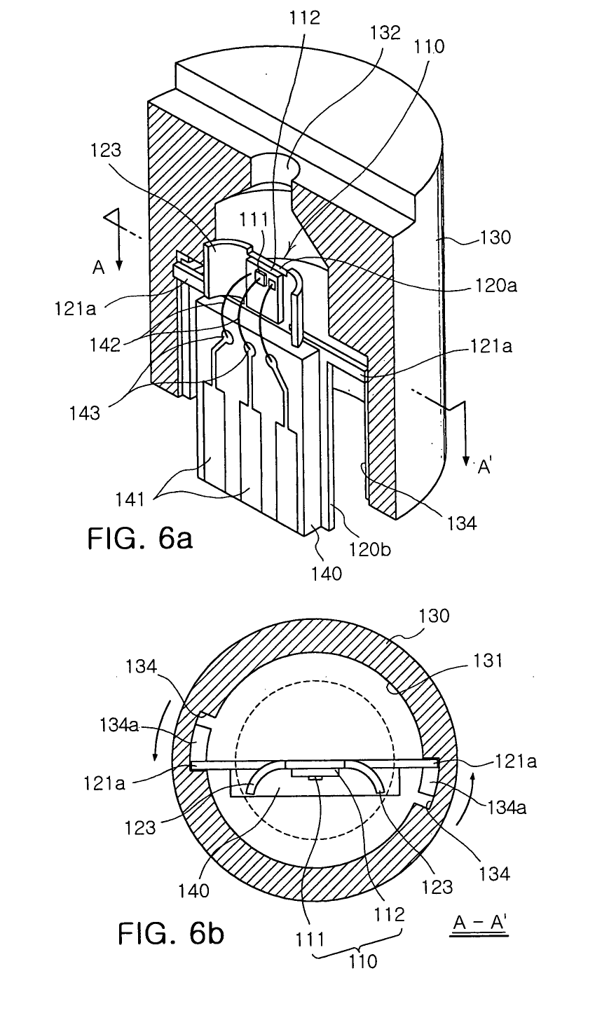

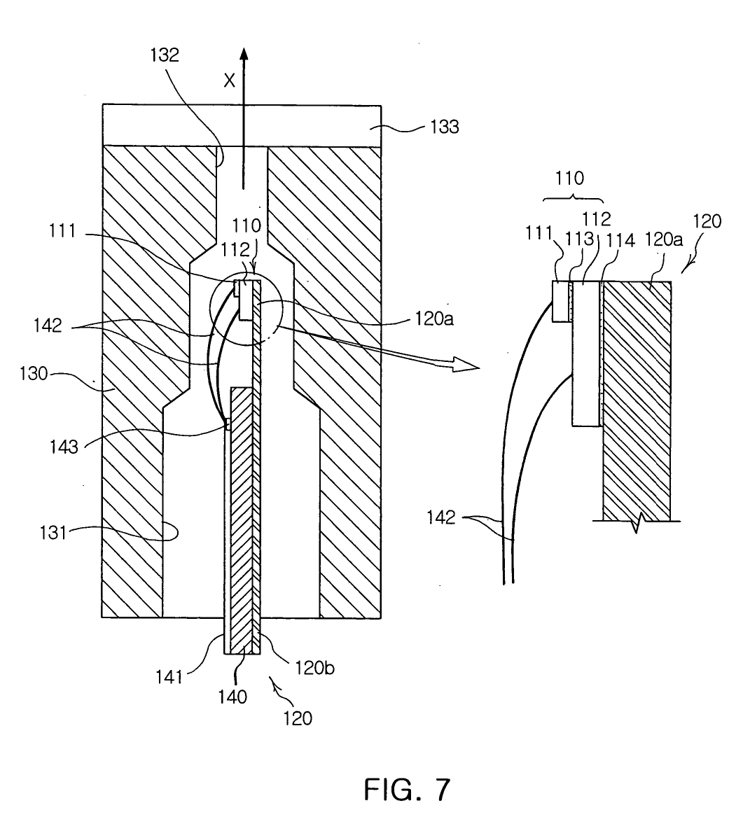

FIG. 4 is an exploded perspective view of a semiconductor laser diode having a PCB type lead frame according to a first embodiment of the invention, FIG. 5 is a perspective view of an assembly including a luminous element, a frame unit and a PCB in the semiconductor laser diode having a PCB type lead frame according to the first embodiment of the invention, FIG. 6A is a magnified perspective view of the semiconductor laser diode having a PCB type lead frame according to the first embodiment of the invention, FIG. 6B is a plan view of FIG. 6A, and FIG. 7 is a longitudinal sectional view of the semiconductor laser diode having a PCB type lead frame according to the first embodiment of the invention.

As shown in FIGS. 4 through 7, a laser diode 100 according to the first embodiment of the invention comprises a luminous element 110, a frame unit 120, a housing 130 and a Printed Circuit Board (PCB) 140, and can be simply assembled by inserting the frame unit 120 having the luminous element 110 into the housing 130.

That is, the luminous element 110 for creating and outwardly emitting a laser beam in response to application of electric power is provided in the form of an integral die chip so that a laser chip 111 and a photodiode 112 can be die bonded to a front face of the frame unit 120.

The laser chip 111 is made of GaAlAs based material containing an active layer and a cladding layer surrounding the active layer, AlGaIP and AlGaInPAs based material used in a red semiconductor laser device of a high density optical disk, GaN based material used in electronics and so on. A rear electrode is bonded onto a surface electrode of the photodiode 112 via a bonding layer 113.

For the purpose of epoxy die boding, the bonding layer 113 may be made of Au or Ag. Alternatively, the bonding layer 113 may comprise a bonding adhesive made of Sn.

Further, the integral photodiode 112 having the laser chip 111 bonded to the upper face thereof has surface and rear electrodes formed in a silicon-based crystal of a P—I—N structure, and the surface electrode is in ohmic contact with a light receiving section having a P diffusion area.

The laser chip 112 is bonded to the surface electrode of the photodiode 111 via the bonding layer 113. The rear electrode is bonded to a front portion of an upper section 120a of the frame unit 120 above a central lead frame 121 via the bonding layer 114 made of Au—Sn or Sn according to eutectic die bonding technique.

Further, in addition to the central lead frame 121 bonded with the luminous element 110, the frame unit 120 comprises auxiliary lead frames 122 arranged at both sides of the central lead frame 121. The central lead frame 121 mounted with the luminous element 110 is integrally provided with heat-radiating sections 123 for outwardly radiating heat which is generated during creation of a laser beam in the luminous element 110.

The housing 130 has an internal space 131 formed in a central body portion communicating with an exit hole 132 for allowing the laser beam from created the luminous element 110 to pass through the same. The frame unit 120 is arranged within the internal space 131 to protect the luminous element 110 mounted on the frame unit 120 from the external environment.

The frame unit 120 is shaped as a quadrangular plate made of metal such as copper, iron and alloys thereof having excellent heat conductivity, machinability and bending ability. The housing 130 is made of resin through injection molding to form the internal space 131 and the exit hole 132 in the central body portion.

As a result, high temperature heat from the laser beam which is generated in actuation of the luminous element 110 can be transferred through the entire area of the frame unit 120 to be uniformly radiated, and the frame unit 120 can be machined or worked easily.

At both sides of the frame unit 120, there is provided a laterally symmetric wing section 121 for mounting the frame unit 120 within the internal space 131 of the housing 130.

The wing section 121 comprises two wing pieces 121a which are extended laterally from right and left peripheral portions of the frame unit 120. On the other hand, the housing 130 has holding grooves 134 formed in inner peripheral portions of the internal space 131 to a predetermined depth in an exit direction X of the laser beam so that the wing pieces 121a are inserted into the holding grooves 134 and then fixed thereto.

As a result, the wing pieces 121a are aligned with the holding grooves 134 formed in the internal space 131 of the housing 130 and then the frame unit 120 is inserted into the internal space 131 of the housing 130 in the laser beam exit direction X in order to assemble the frame unit 120 having the right and left wing pieces 121a to the housing 130.

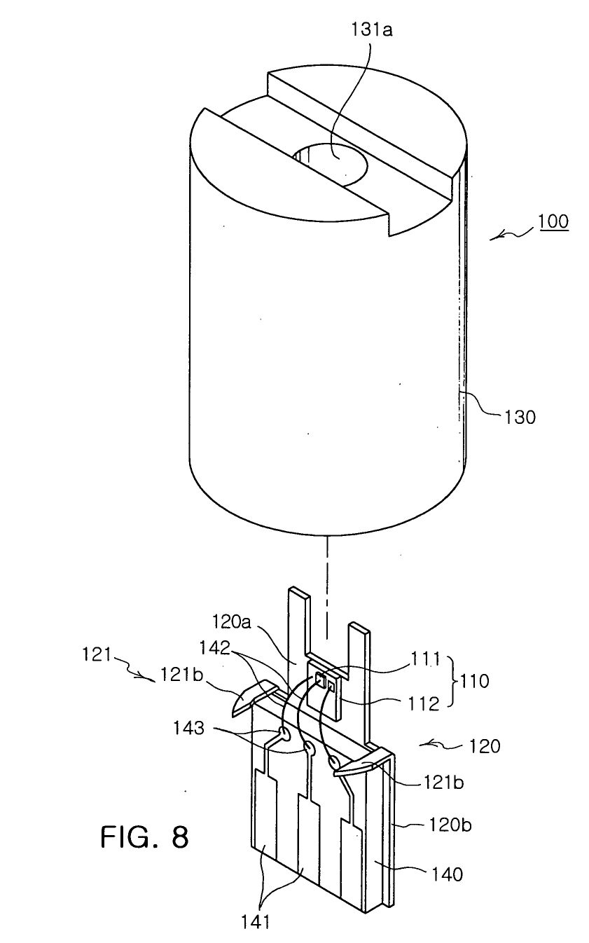

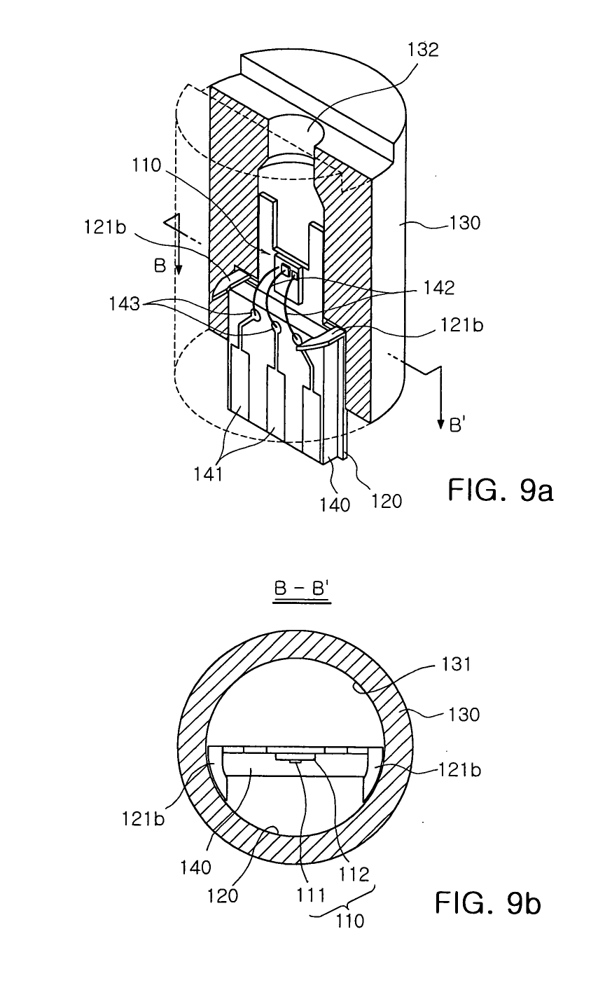

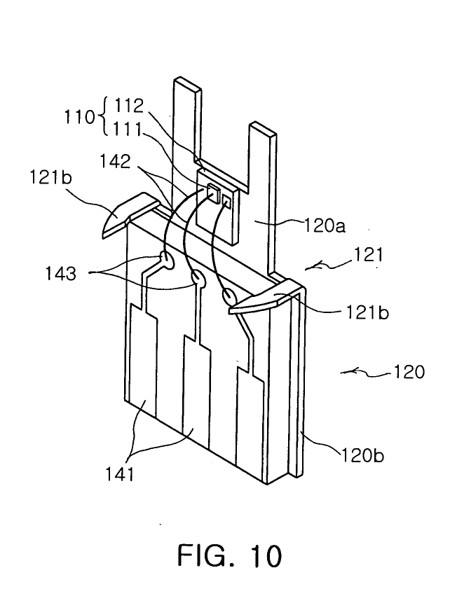

FIG. 8 is an exploded perspective view of a semiconductor laser diode having a PCB type lead frame according to a second embodiment of the invention, FIG. 9A is a magnified perspective view of the semiconductor laser diode having a PCB type lead frame according to the second embodiment of the invention, FIG. 9B is a plan view of FIG. 9A, and FIG. 10 is a perspective view of an assembly including a luminous element, a frame unit and a PCB in the semiconductor laser diode having a PCB type lead frame according to the second embodiment of the invention.

The wing section 121 provided at the both sides of the frame unit 120 according to the first embodiment of the invention can be substituted by arc-shaped wing pieces 121b according to the second embodiment of the invention which are elastically contacted with inner peripheral portions of an internal space 131 of a housing 130 as shown in FIGS. 8 through 10.

The arc-shaped wing pieces 121b form portions of an imaginary circle drawn at an outside diameter which is substantially same as or slightly larger than the inside diameter of the internal space 131 so that the arc-shaped wing section 121 inserted into the internal space 131 of the housing 130 is press fit with the inner peripheral portions of the internal space 131.

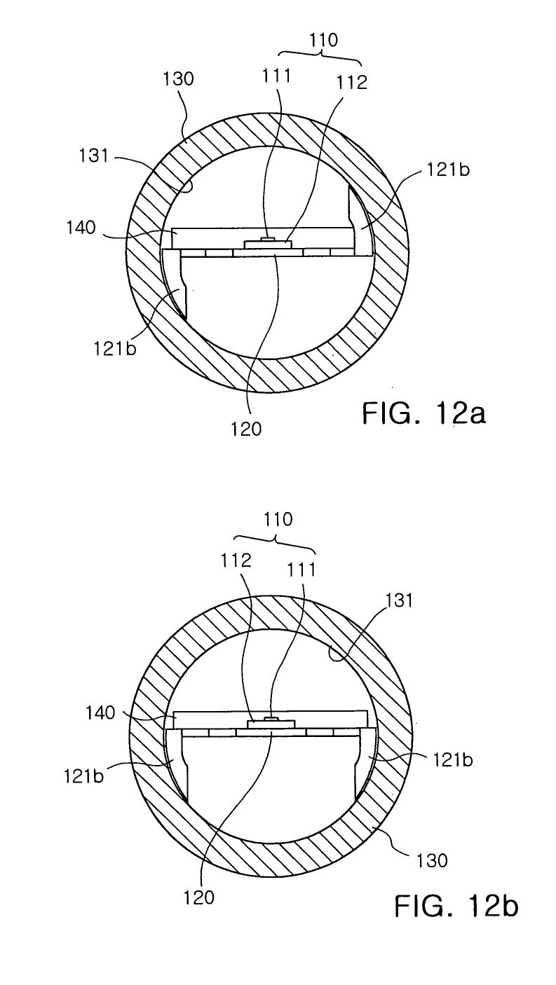

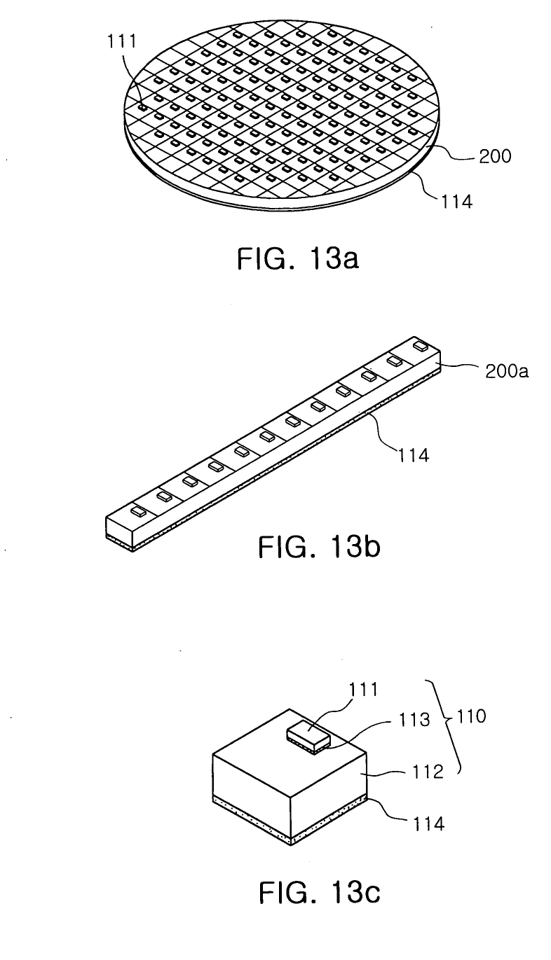

The arc-shaped wing pieces 121b tightly contacted with the inner peripheral portions of the internal space 131 may be projected forward or backward perpendicular to a front or rear face of the frame unit 120 as shown in FIGS. 12A and 12B.

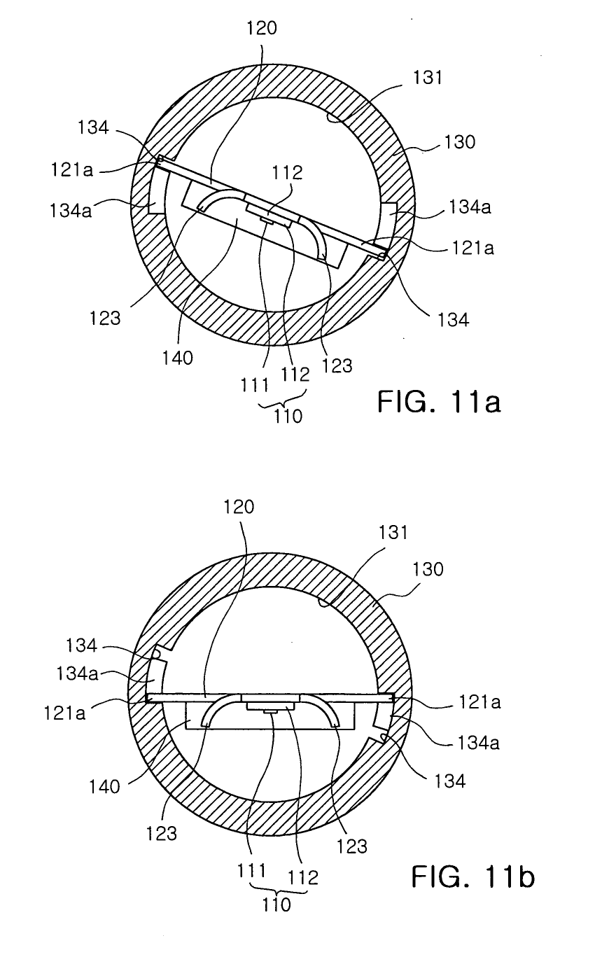

As shown in FIGS. 11A and 11B, in lateral peripheral portions of an upper section 120a of the frame unit 120 to which the luminous element 110 is die bonded, there are provided protective wings 123 which are bent in the form of arcs to surround and protect the luminous element 110 as those shown in FIGS. 4 through 6B. The surface of the upper section 120a to which the luminous element is bonded is formed flat.

Ends of the protective wings 123 are preferably formed higher than the uppermost portion of the luminous element 110 to the extent that a finger of a worker may not contact the luminous element 110 that is a precision component when the frame unit 120 is assembled to the housing 130 in an assembly line.

Further, a PCB 140 is bonded to a lower section 120b of the frame unit 120 via an adhesive such as epoxy, arranged coplanar with the luminous element 110. The PCB 140 also has a plurality of pattern electrodes 141 which are printed on a front face thereof and electrically connected with the luminous element 110.

The pattern electrodes 141 are wire bonded to be electrically connected with the luminous element 110 via wire members 142 made of metal such as Au and Ag.

The pattern electrodes 141 are extended up to an upper peripheral portion of the PCB 140 in close proximity of the luminous element 110 to form upper terminals 143 which are connected with lower ends of the wire members 142 so that the wire members 142 are provided at minimum lengths to connect the pattern electrodes 141 with the luminous element 110.

The PCB 140 is provided as a single sided PCB with the pattern electrodes 141 formed on the front face of the PCB 140, and preferably has a width smaller than that of the lower section 120b of the frame unit 120.

The operation of the invention having the above construction will be described as follows.

According to a fabrication process of a luminous element 110 for emitting a laser beam, a bonding layer 114 made of Au—Sn or Sn is formed on one side of a substrate 200 in the form of a wafer, and then an upper face of the substrate 200 is partitioned into a matrix.

Laser chips 111 are mounted on matrix-shaped partitioned sections of the substrate 200 according to die bonding technique, in which each of the laser chips 111 is mounted on each of the partitioned sections via a bonding layer 113 made of Sn. The substrate 200 mounted with the laser chips 111 is cut longitudinally to form a plurality of bars 200a.

Each of the bars 200a is scribed laterally and then cut along the scribed lines to form a plurality of luminous elements 110 each having a laser chip 111 and a photodiode 112 integrally bonded thereto.

In subsequence, each of the luminous elements 110 is placed so that the photodiode 112 as a base is seated on an upper section 120a of a frame unit 120 according to any of the first and second embodiments of the invention. A heat source having a temperature of about 300° C. is provided to a junction between the luminous element 110 and the frame unit 120 having a plated layer of Au or Ag at a thickness of about 3 μm to weld the plated layer of the frame unit 120 with the bonding layer 114 of the photodiode 112 according to eutectic die bonding technique so that the each luminous element 110 is arranged in the upper section 120a of the frame unit 120.

Adhesive such as epoxy is coated on a front face of a lower section 120b of the frame unit 120 via dotting, and then a rear face of a PCB 140 having a plurality of pattern electrodes 141 formed in a front face thereof is attached to the epoxy-coated front face of the lower section 120b.

The luminous element 110 mounted on the upper section 120a of the frame unit 120 is electrically connected with the PCB 140 mounted on the lower section 120b of the frame unit 120 by connecting one ends of wire members 142 with the luminous element 110 and bonding the other ends of the wire members 142 with upper terminals 143 of the pattern electrodes 141 extended adjacent to upper peripheral portions of the PCB 120 so that electric power for generating a laser beam can be supplied to the luminous element 110 via the pattern electrodes 141 and the wire members 142.

The frame unit 120 mounted with the luminous element 110 and the PCB 140 which are wire bonded to each other is assembled to the housing 130 as follows: Where the wing section 121 has the wing pieces 121a extended laterally from the both lateral peripheral portions of the frame unit 120 as shown in FIG. 4 and FIGS. 11A and 11B, distal ends of the wing pieces 121a are aligned with the holding grooves 134 formed in the inner peripheral portions of the internal space 131 of the housing 130.

The frame unit 130 is inserted into the internal space 131 in the exit direction X or along the central axial of the internal space 131 with the distal ends of the wing pieces 121a moved upward along the holding grooves 134 until the distal ends of the wing pieces 121a are stopped by upper ends of the holding grooves 134. Then, the frame unit 120 is turned to the right or the left within the internal space 131 so that the distal ends of the wing pieces 121 a are inserted into and held by fitting grooves 134a which are extended perpendicularly in a radial direction from the upper ends of the holding grooves 134. As a result, the frame unit 120 is securely held within the housing 130 so that it is not released from the housing 130.

Further, where the wing section 121 comprises the arch-shaped wing pieces 121b which are projected from the both lateral peripheral portions of the frame unit 120 forward or backward perpendicular to the front or rear face of the frame unit 120, the upper portion of the frame unit 120 having the arc-shaped wing pieces 121b is aligned with a lower end of the internal space 131 of the housing 130 as shown in FIGS. 12A and 12B.

In this position, the frame unit 130 is inserted into the internal space 131 in the exit direction X or along the central axial of the internal space 131 so that the arc-shaped wing pieces 121b are inserted along the internal space 131 causing outer peripheral portions of the arc-shaped wing pieces 121b to be elastically pressed against the inner periphery of the internal space 131. As a result, the frame unit 120 can be securely held within the internal space 131 of the housing 130 so that it is not released from the housing 130.

Both of the arc-shaped wing pieces 121b of the wing section 121 can be projected forward with respect to the front face of the frame unit 120 or backward with respect to the rear face of the frame unit 120. Alternatively, the arc-shaped wing pieces 121b of the wing section 121 can be alternatively projected with respect to the frame unit 120, that is, one of the arc-shaped wing pieces 121b is projected forward with respect to the front face of the frame unit 120 and the other one of the arc-shaped wing pieces 121b is projected backward with respect to the rear face of the frame unit 120. In the circumstances, all configurations of the arc-shaped wing pieces 121b provide equal areas which are pressed against the inner peripheral portions of the internal space 131 so as to impart the same securing force to the wing section 121 regardless of the configuration of the arc-shaped wing pieces 121b.

According to the present invention as set forth above, the frame unit having the luminous element and the PCB in electric connection with the luminous element which are mounted on the front face thereof is received within the internal space of the housing with the exit hole formed therein so as to simplify the structure of the assembly line thereby saving the manufacturing cost of a final product while enhancing the productivity thereof.

The frame unit having the wide heat-radiating surface area can efficiently radiate high temperature heat which is generated from the luminous element during emission of the laser beam through the exit hole to the outside to enhance heating characteristics of the final product thereby improving the reliability thereof.

The protective wing pieces are formed at the both lateral sides of the frame unit to surround and protect the wire members and the luminous element as precision components in order to reliably prevent the luminous element and the wire members from contacting with a finger of a worker. This resultantly prevents the components of the frame unit from malfunction or damage owing to pollutants sticking to the same.

While the present invention has been described in connection with the preferred embodiments of the invention, it is also to be understood that various modifications and variations can be made without departing from the spirit or the scope of the invention, which is not restricted to the above described embodiments but shall be defined by the appended claims and equivalents thereof.

1. A laser diode having a PCB type lead frame, comprising:
a luminous element for emitting a laser beam;
a frame unit having an upper section mounted with the luminous element and functioning to radiate heat generated during creation of the laser beam;
a housing having an internal space for receiving the frame unit and an exit hole communicating with the internal space for allowing the laser beam to pass through the same; and
a Printed Circuit Board (PCB) having a plurality of pattern electrodes formed on an upper face of the PCB, the pattern electrodes being electrically connected with the luminous element.

2. The laser diode having as set forth in claim 1, wherein the luminous element includes a photodiode which is die bonded to an upper section of the frame unit and a laser chip which is die bonded to an upper face of the photodiode.

3. The laser diode having as set forth in claim 1, wherein the frame unit comprises a metal plate having an excellent heat conductivity.

4. The laser diode having as set forth in claim 1, wherein the frame unit has a wing section formed at both sides thereof, and is mounted within the internal space of the housing.

5. The laser diode having as set forth in claim 4, wherein the housing has holding grooves formed axially in inner peripheral portions of the internal space of the housing, and wherein the wing section includes wings which are extended laterally from both lateral peripheral portions of the frame unit to be inserted into the holding grooves and fixed therein.

6. The laser diode having as set forth in claim 5, wherein each of the holding grooves has a fitting groove extended radially in a top portion thereof.

7. The laser diode having as set forth in claim 4, wherein the wing section includes arc-shaped wings which are elastically contacted with inner peripheral portions of the internal space of the housing.

8. The laser diode having as set forth in claim 7, wherein the arc-shaped wings are projected forward or backward perpendicular to a front or rear face of the frame unit.

9. The laser diode having as set forth in claim 1, wherein the frame unit has arc-shaped protective wings formed at both lateral peripheral portions of the frame unit to surround and protect the luminous element.

10. The laser diode having as set forth in claim 9, wherein each of the protective wings has an end which is formed higher than the uppermost portion of the luminous element.

11. The laser diode having as set forth in claim 1, wherein the pattern electrodes of the PCB are connected with the luminous element via wire members.

12. The laser diode having as set forth in claim 11, wherein the pattern electrodes of the luminous element are extended to an upper peripheral portion of the PCB in close proximity of the luminous element to form upper terminals in contact with lower ends of the wire members.

13. The laser diode having as set forth in claim 1, wherein the PCB comprises a single sided PCB having a front face on which the pattern electrodes are formed.
